(19) United States
(12) Patent Application Publication
(10) Pub. No.: US 2010/0265031 A1
(43) Pub. Date: Oct. 21, 2010

(54) Surface mount thin film fuse structure and method of manufacturing the same

(76) Inventor: Chun-Chang Yen, Hsinchu City (TW)

Correspondence Address: Jackson Intellectual Property Group PLLC, 106 Starvale Lane, Shipman, VA, 22971, US

(21) Appl. No.: 12/081,869

(22) Filed: Apr. 22, 2008

(30) Foreign Application Priority Data
Dec. 21, 2007 (TW) 096149138

(51) Int. Cl. H01H 85/02; H01H 69/02

(52) U.S. Cl. 337/297; 29/623

(57) ABSTRACT

The present invention discloses a surface mount thin film fuse structure including a fusible fuse circuit structure disposed on a side of an insulating substrate, and the fusible fuse circuit structure has a fusible link portion electrically connected between two opposite electrode portions. If an overload current is passed through the fusible link portion, the fusible link portion will be melted down by a high temperature or a specific temperature to achieve the over current protection effect. At least one space is defined between the fusible link portion and the insulating substrate, such that a heat generated by the electrically energized the fusible link portion will not be dissipated through the heat conduction of the insulating substrate to achieve the circuit protection effect.

### BACKGROUND OF THE INVENTION

(a) Field of the Invention

The present invention relates to a surface mount thin film fuse structure and a method of manufacturing the surface mount thin film fuse, and more particularly to a surface mount thin film fuse and a method of manufacturing the surface mount thin film fuse that assure the effect of blowing the fuse at a specific current or a specific temperature to protect a circuit against an overload current.

(b) Description of the Prior Art

In general, an electric device is set to consume a maximum current for its use, and thus the device may be damaged or burned by an overload current easily, and a fuse is provided to prevent an overload current from passing through an electronic circuit. If an overload current is passed through a fuse, the fuse will produce a high temperature to blow the fuse in order to protect the circuit from being damaged. In present existing electric devices such as information, communication and consumer electronic products mainly use a printed circuit board (PCB) to connect electronic components to maximize the overall performance. Since the electric devices become more complicated and require more components, the layout of circuits and components on the printed circuit board becomes increasingly denser.

At present, the technology adopted for packaging components of a printed circuit board is divided mainly into a through hole technology (THT) or a surface mount technology (SMT), and the through hole technology (THT) installs components on a side of the PCB and solders pins on the other side, and thus the components of this technology occupy a larger space, and a bore hole is required for each pin on the printed circuit board. As a result, the pins occupy more spaces on both sides of the PCB and the solder joints of the pins are bigger. On the other hand, the SMT sets a surface mount device (SMD) on a PCB adhered with glue or solder paste, and then fixes the devices on a surface of the printed circuit board by a heating technology. Unlike traditional THT, SMT does not insert the pins of components into the bored holes of a PCB to support the weight of the components or maintain the direction of the components. In addition, the electrodes of the SMD and PCB are situated on the same side having the components, and thus the components can be installed on both sides of the PCB. Compared with a PCB produced by THT, the layout of components on a SMT PCB can be denser. In other words, more functions can be bundle into a PCB of equal area, or maintain the same functions by a smaller area of PCB.

For the same reason, the fuses used in devices requiring an overload current protection also adopt the SMT for their manufacture. Referring to FIG. 1 for a sectional view of a prior art surface mount fuse structure, the surface mount fuse includes two opposite electrode portions 12 disposed on two opposite positions at the bottom side of an insulating substrate 11 (such as FR4) made of a material similar to that of a printed circuit board, and the two opposite electrode portions 12 are extended along external walls to the top side of the insulating substrate 11, and connected simply by a fusible link portion 13 comprised of a plated copper film. The surface mount fuse further installs a tin layer 14 at the middle of the fusible link portion 13, and the tin layer 14 is different from the copper meterial of the fusible link portion 13, so that when the tin layer 14 is melted by an overload current, the fusible link portion 13 is changed to a tin/copper alloy, and the fusible link portion 13 has a melting point lower than that of the individual tin or copper, and the operating temperature at the fusible link portion 13 is lowered to improve the overall performance of the fuse. Further, a protective layer 15 made of a photoimageable material is disposed on the top side of the insulating substrate 11 for protecting the fusible link portion 13 and its tin layer 14 from being oxidized and providing a shield effect to prevent the sputter of melted metal.

When use, the surface mount fuse electrically connects a circuit composed of two opposite electrode portions 12 by the fusible link portion 13, so that when an overload current is passed through the fusible link portion 13, a high temperature or a specific temperature is produced at the fusible link portion 13 to achieve the over current protection effect. However, if the fusible link portion 13 is electrically connected and operated to produce a heat source, the heat source at the fusible link portion 13 is conducted and dissipated from the insulating substrate 11, since the fusible link portion 13 is in a direct contact with the insulating substrate 11. When the overload current is passed through the fusible link portion 13, a specific current or a specific high temperature of the fusible link portion 13 cannot be achieved to blow the fuse, and the over current protection effect cannot be achieved. As a result, the electronic circuits of the electric devices will be damaged or burned easily.

### SUMMARY OF THE INVENTION

The primary objective of the present invention is to provide a surface mount thin film fuse structure and a method of manufacturing the surface mount thin film fuse structure that assure the effect of blowing the fuse at a specific current or a specific temperature to protect a circuit against an overload current.

To achieve the foregoing objective, the present invention provides a surface mount thin film fuse structure comprising a fusible fuse circuit structure disposed on at least one side of an insulating substrate, and having a fusible link portion electrically connected between two opposite electrode portions, such that when an overload current is passed through fusible link portion, a heat source of a high temperature or a specific temperature is generated to blow the fuse to achieve the an over current protection effect, and at least one space is defined between the fusible link portion and the insulating substrate, such that a heat generated by the electrically energized the fusible link portion will not be dissipated through the heat conduction of the insulating substrate, so as to assure the effect of blowing the fuse at a specific current or a specific temperature to protect a circuit.

### BRIEF DESCRIPTION OF THE DRAWINGS

FIG. 1 is a schematic view of a prior art surface mount thin film fuse structure;

FIG. 2 is a schematic view of a surface mount thin film fuse structure of the present invention;

FIG. 3 is a perspective view of a surface mount thin film fuse structure of the present invention;

FIGS. 4 to 9 are schematic views of installing a surface mount thin film fuse structure of the present invention;

FIGS. 10 and 11 are schematic views of installing another surface mount thin film fuse structure of the present invention;

FIG. 12 is a schematic view of installing another structure as described in Step B of a method in accordance with the present invention;

FIG. 13 is a schematic view of a double-sided surface mount thin film fuse structure of the present invention;

FIG. 14 is a schematic view of a lateral-sided surface mount thin film fuse structure of the present invention;

FIG. 15 is a schematic view of another double-sided surface mount thin film fuse structure of the present invention; and

FIG. 16 is a schematic view of another lateral-sided surface mount thin film fuse structure of the present invention.

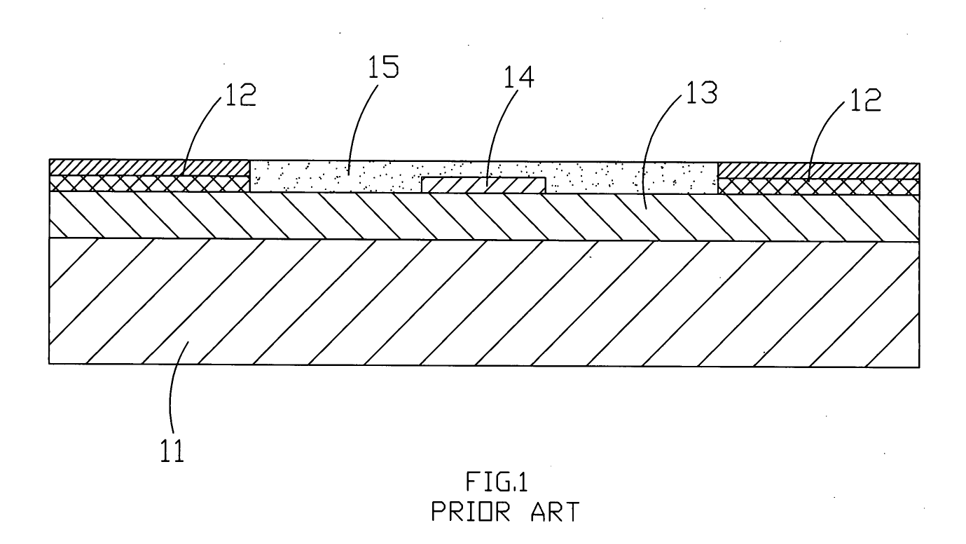

### DETAILED DESCRIPTION OF THE PREFERRED EMBODIMENTS

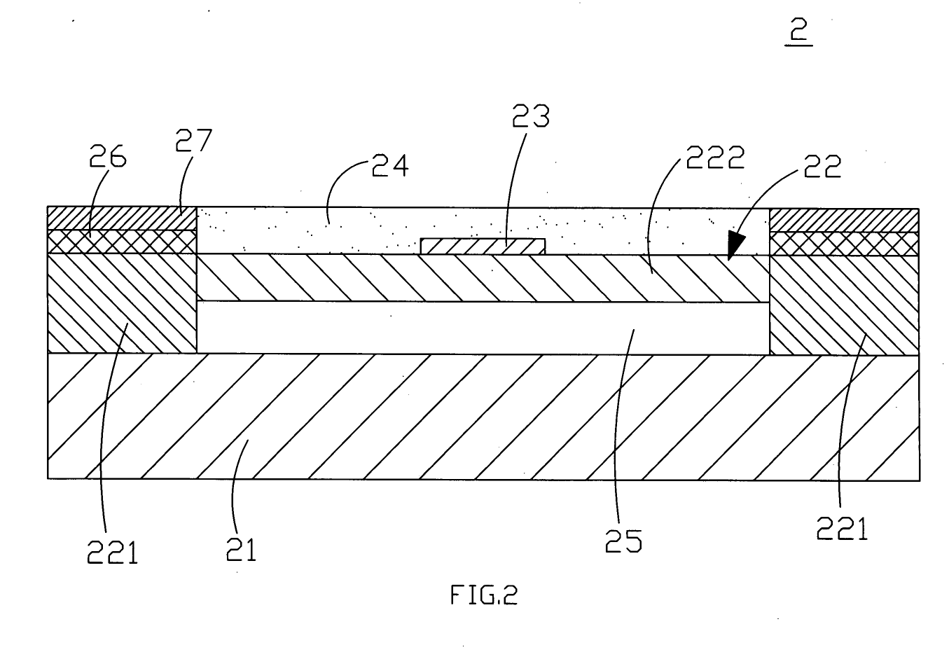

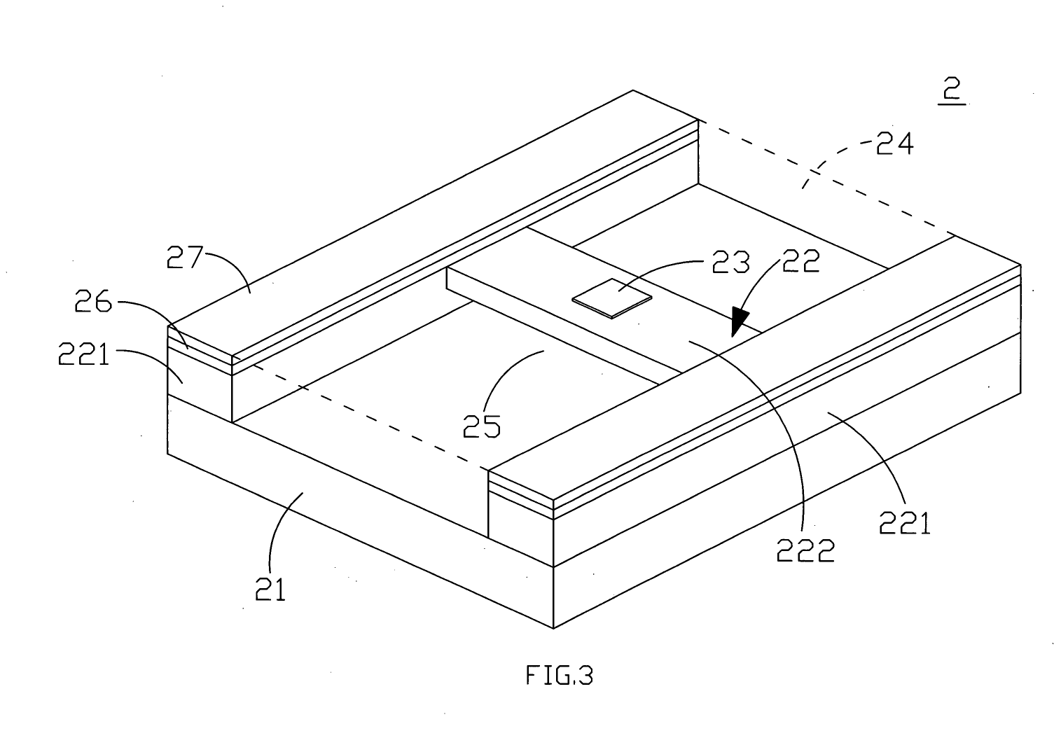

Referring to FIGS. 2 and 3 for a surface mount thin film fuse structure and a method of manufacturing the surface mount thin film fuse structure in accordance with the present invention, the surface mount thin film fuse structure 2 comprises a fusible fuse circuit structure 22 disposed on at least one surface of an insulating substrate 21, and further comprising two opposite electrode portions 221 and a fusible link portion 222, wherein the fusible link portion 222 is connected electrically to the two opposite electrode portions 221, and the fusible link portion 222 has a tin layer 23 disposed at the middle of a surface of the fusible link portion 222, and a protective layer 24 disposed on the fusible link portion 222 of the fusible fuse circuit structure for preventing the fusible link portion 222 and the tin layer 23 from being oxidized or sputtered by melted metals. At least one space 25 is defined between the fusible link portion 222 and the insulating substrate 21, such that the fusible link portion 222 and the insulating substrate 21 are not in a direct contact with each other, and a heat source of the fusible link portion 222 will not be conducted or dissipated from the insulating substrate 21, so as to assure the effects of blowing the fusible link portion by a high temperature and protecting a circuit against an overload current.

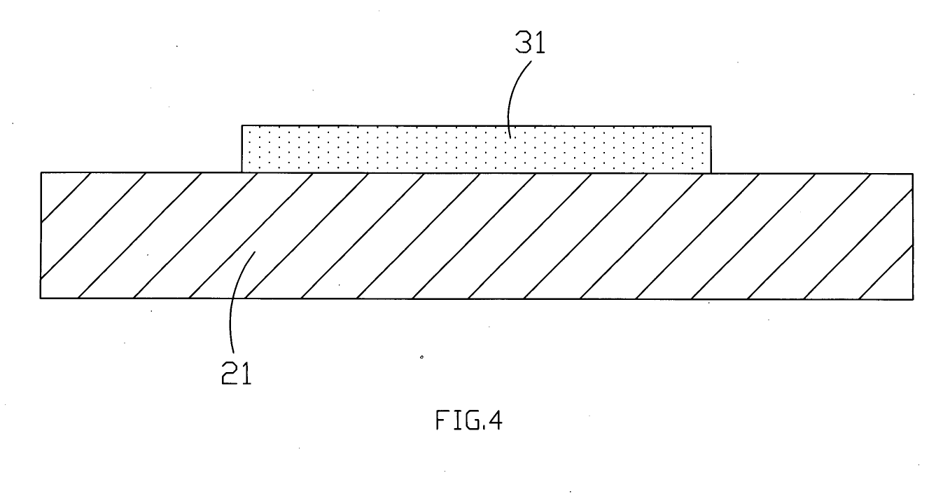

Referring to FIGS. 4 to 9 for a method of manufacturing a surface mount thin film fuse structure in accordance with the present invention, the method comprises the following steps:

Step A: Provide an insulating substrate 21 as shown in FIG. 4, wherein the insulating substrate 21 is a substrate made of epoxy resin fiberglass, polyimide, polyimide fiberglass or ceramic, etc.

Step B: Install a spacer layer 31 on at least one side of the insulating substrate 21 as shown in the figure, wherein the spacer layer 31 is disposed on a surface of the insulating substrate 21 and at a desired position for installing the fusible link portion.

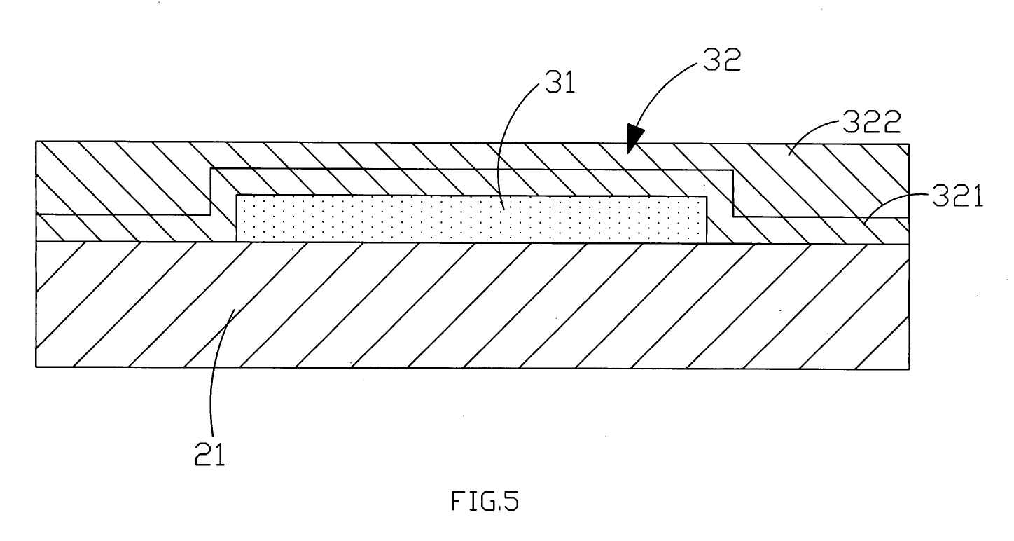

Step C: Install a copper layer 32 on a side of the insulating substrate 21 having the spacer layer 31 and cover the whole insulating substrate 21 with the copper layer 32 as shown in FIG. 5. The Step C further includes Steps C1 and C2, and the Step C1 performs a copper deposition process to cover a chemically deposited copper layer 321 fully on a side of the insulating substrate 21 having the spacer layer 31, and the Step C2 performs a copper plating process to cover a plated copper layer 322 completely on the chemically deposited copper layer 321, and the chemically deposited copper layer 321 and the plated copper layer 322 constitute the structure of a copper layer 32.

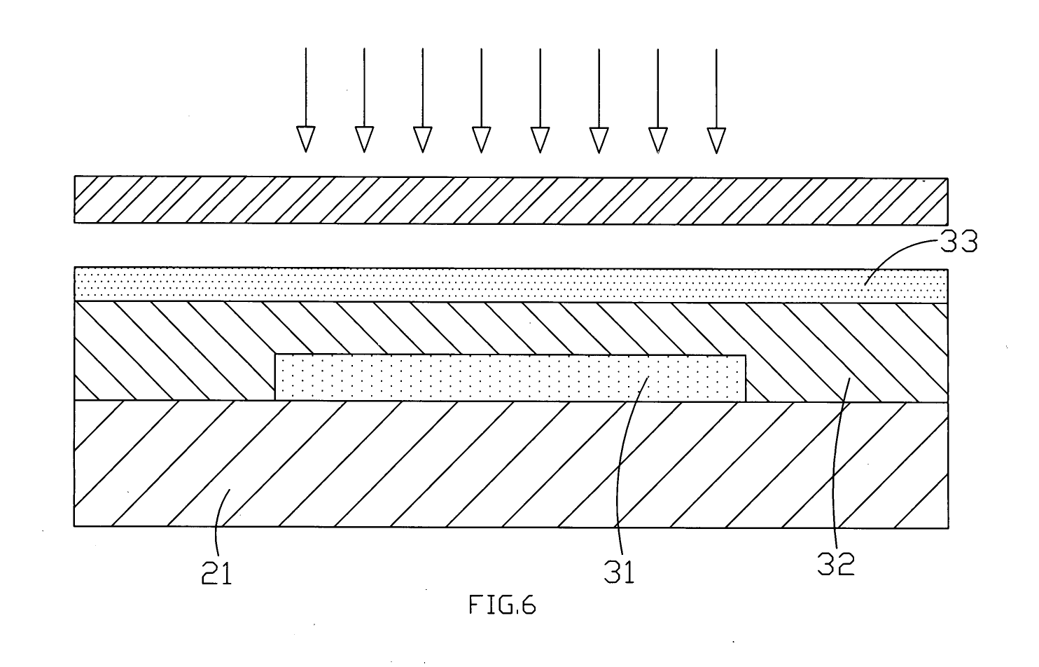

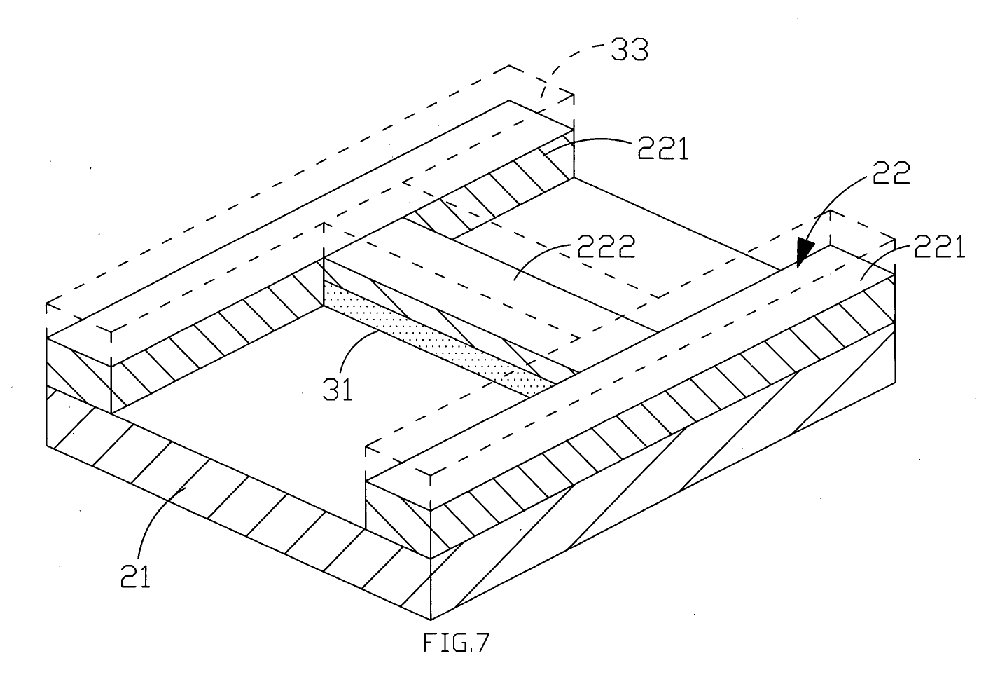

Step D: Coat a photoresist 33 on the copper layer 32 as shown in FIG. 6, and perform exposure, development and etching processes to form the copper layer into a fusible fuse circuit structure 22 as shown in FIG. 7, wherein the fusible fuse circuit structure 22 comprises two opposite electrode portions 221 and a fusible link portion 222 which is connected electrically to the two opposite electrode portions 221.

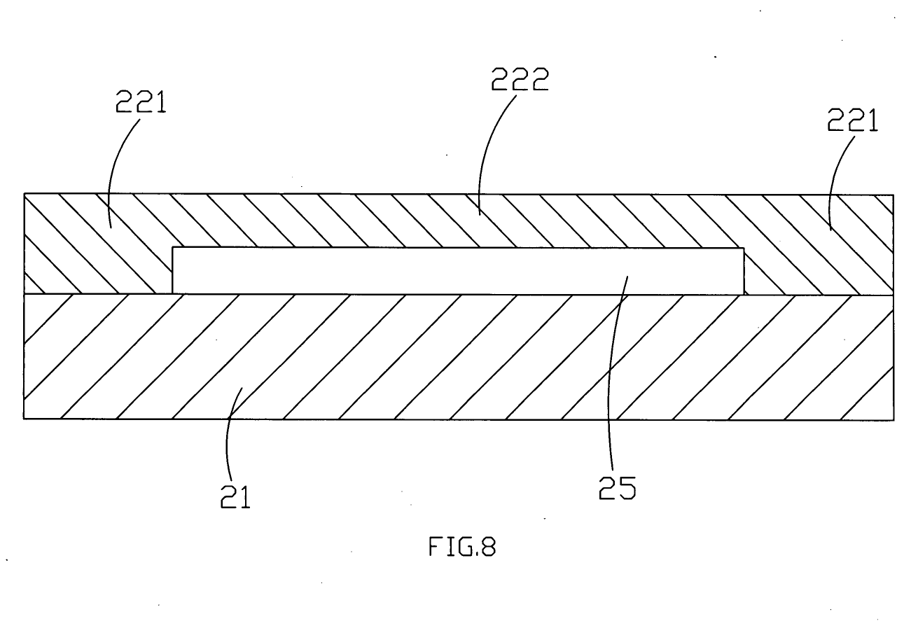

Step E: Remove a spacer layer 31, and the spacer layer 31 can be made of a photoresist material, wherein the photoresist can be a dry film or liquid photoresist, and the photoresist 33 remained on the fusible fuse circuit structure 22 and the spacer layer 31 can be removed by a chemical solvent, so that at least one space 25 is formed between the fusible link portion 222 and the insulating substrate 21 as shown in FIG. 8.

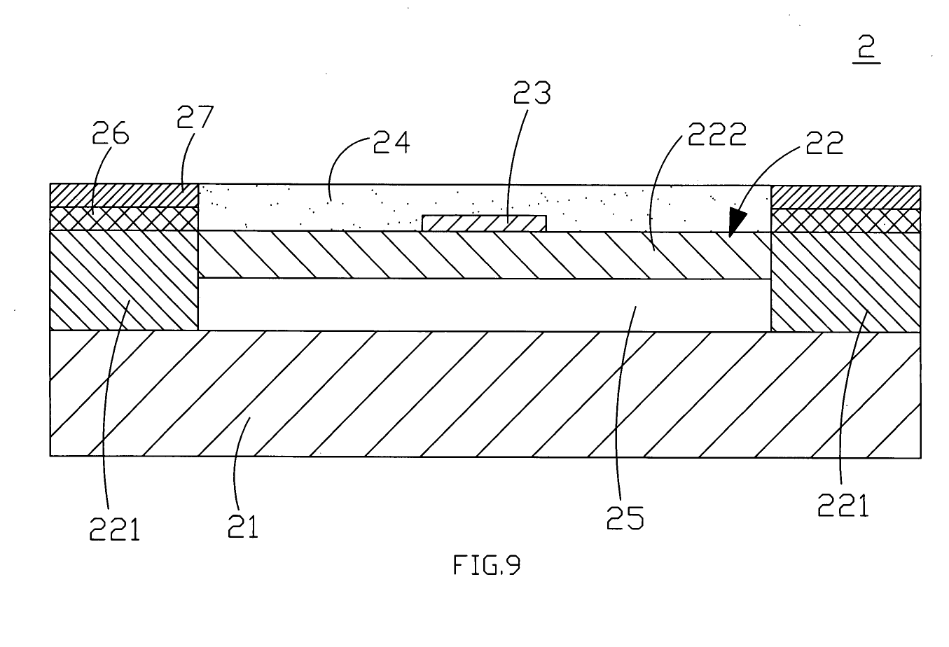

Step F: Install a tin layer 23 at the middle of a surface of the fusible link portion 222 as shown in FIG. 9.

Step G: Install a nickel layer 26 and a tin layer 27 sequentially on a surface of the two opposite electrode portions 221.

Step H: Install a protective layer 24 at a position of the fusible link portion 222 of the fusible fuse circuit structure to form the surface mount thin film fuse structure 2.

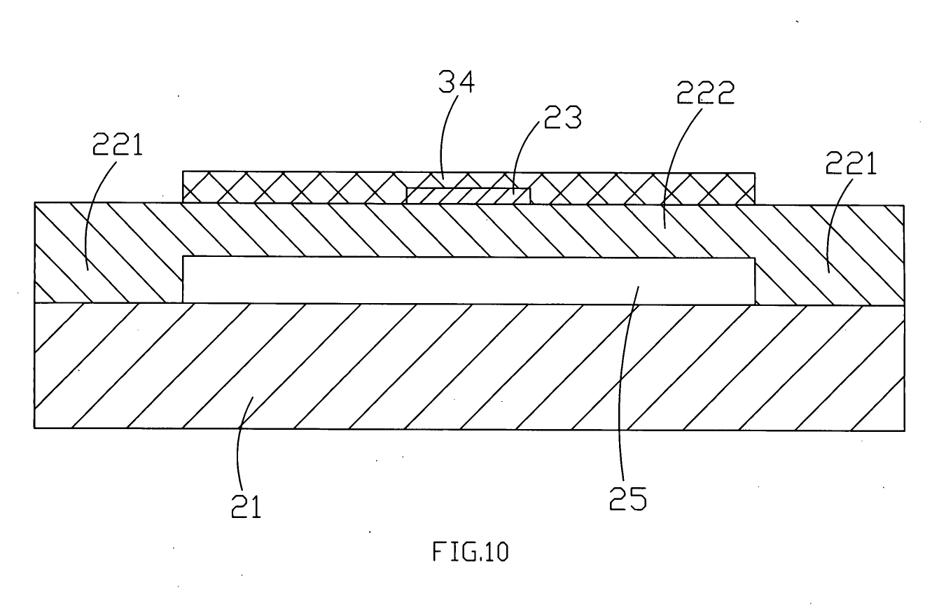

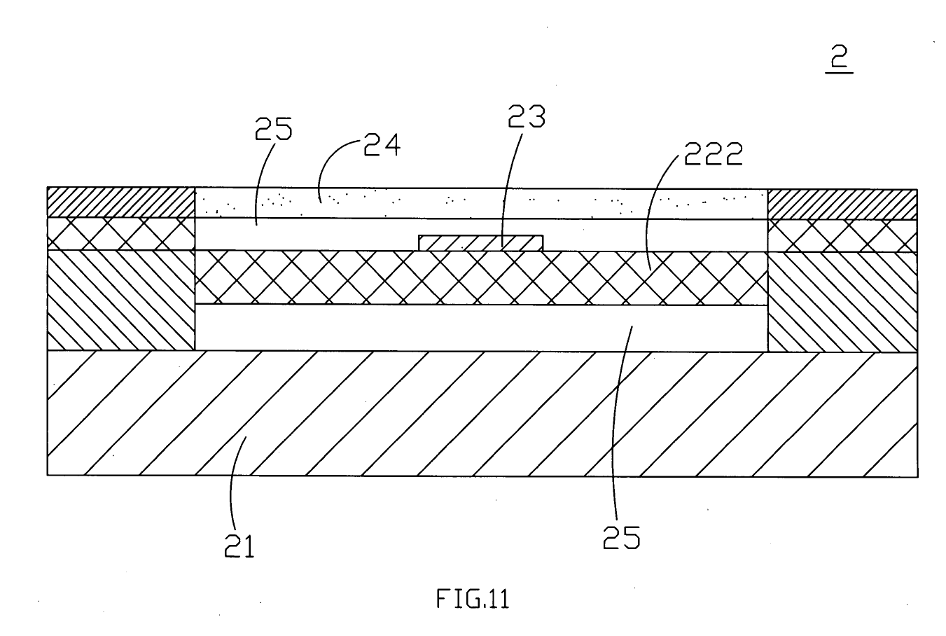

In Step F, the fusible link portion 222 and the tin layer 23 further include a second spacer layer 34 as shown in FIG. 10 and the second spacer layer 34 is a hot melt material having a melting point lower than the melting point of the tin layer 23, and the top of the second spacer layer 34 has a protective layer 24, and the second spacer layer 34 is removed by heating, so that at least one space 25 is formed by the protective layer 24, the fuse fusible portion 222 and the tin layer 23 as shown in FIG. 11.

In a spacer layer in accordance with another preferred embodiment of the present invention, the spacer layer is made of a water washable and durable material. In Step E, the spacer layer is washed and removed by a high-pressure water or a chemical solvent, and the photoresist remained on the fusible fuse circuit structure is removed by a chemical solvent, and Steps F to H are performed to produce the surface mount thin film fuse structure 2 as shown in FIG. 9.

In a spacer according to another preferred embodiment of the present invention, the spacer layer is made of a hot melt material, and the melting point of the spacer layer is lower than the melting point of the tin layer. In Step E, the spacer layer is removed by heating, and the photoresist remained on the fusible fuse circuit structure is removed by a chemical solvent. Step F is included between Steps D and E, and Steps G and H are performed sequentially after carrying out the Step F to produce the surface mount thin film fuse structure 2 as shown in FIG. 9.

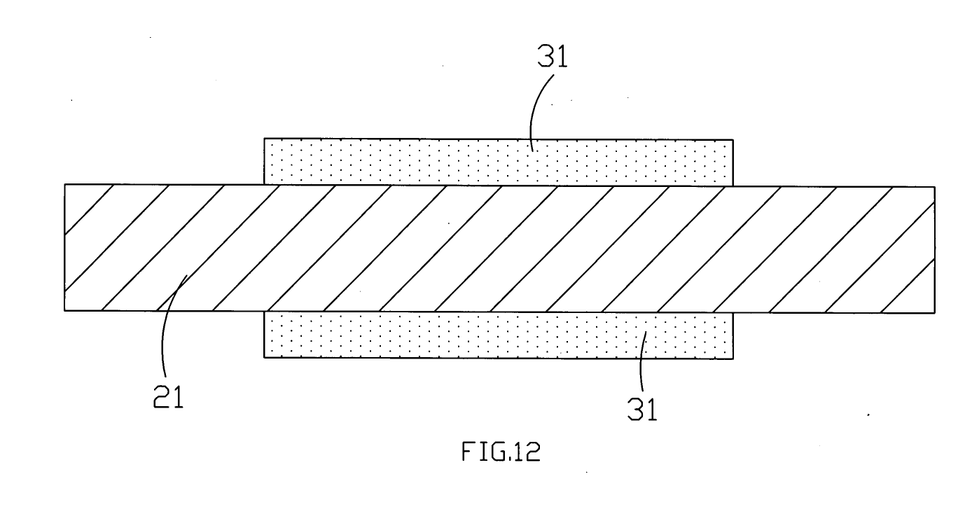

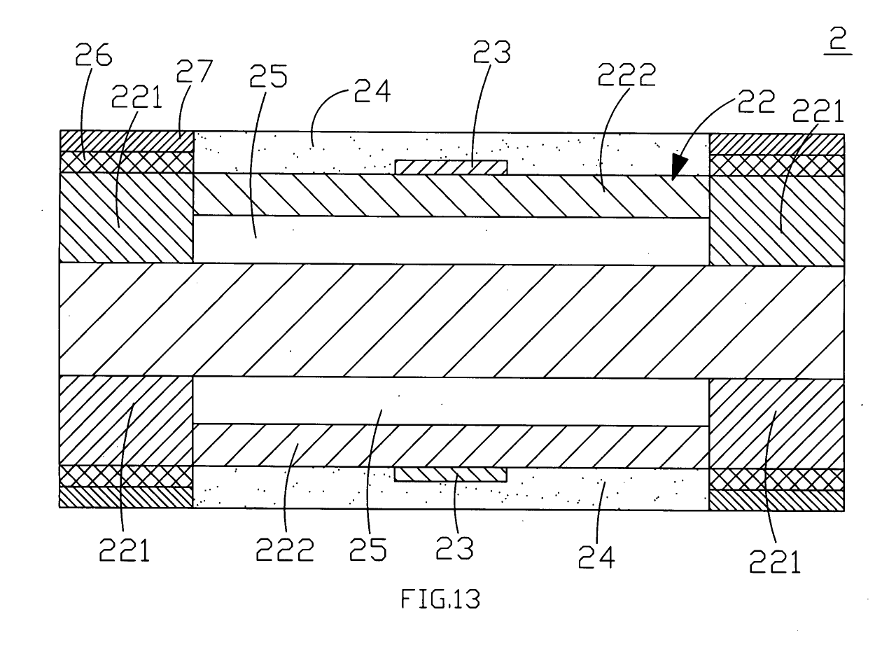

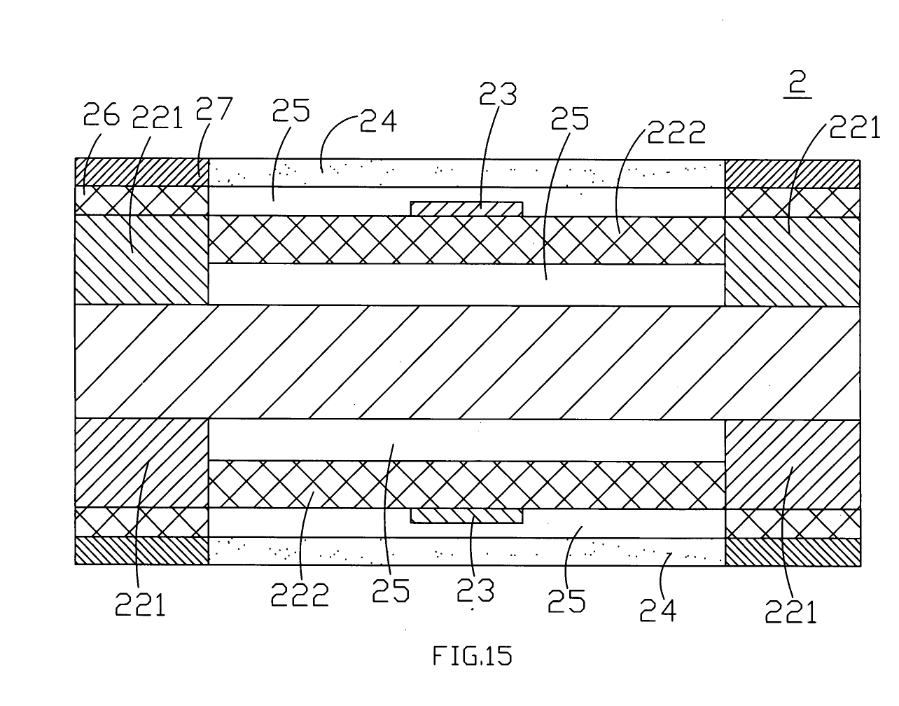

Referring to FIG. 12 for another preferred embodiment of the present invention, Step B installs a spacer layer 31 separately on both sides of the insulating substrate 21, and the spacer layer 31 of the aforementioned embodiments are made of a photoresist material, a hot melt material or a water washable and durable material. The Steps C to H are performed sequentially to produce a double-sided surface mount thin film fuse structure 2 as shown in FIG. 13, such that each of the two sides of the insulating substrate 21 has two opposite electrode portions 221 and a fusible link portion 222 to constitute the fusible fuse circuit structure 22, wherein the fusible link portion 222 is connected electrically to the two opposite electrode portions 221. In the Step F, at least one space 25 is defined by the protective layer 24, the fusible link portion 222 and the tin layer 23 as shown in FIG. 15 to produce another two-sided surface mount thin film fuse structure 2.

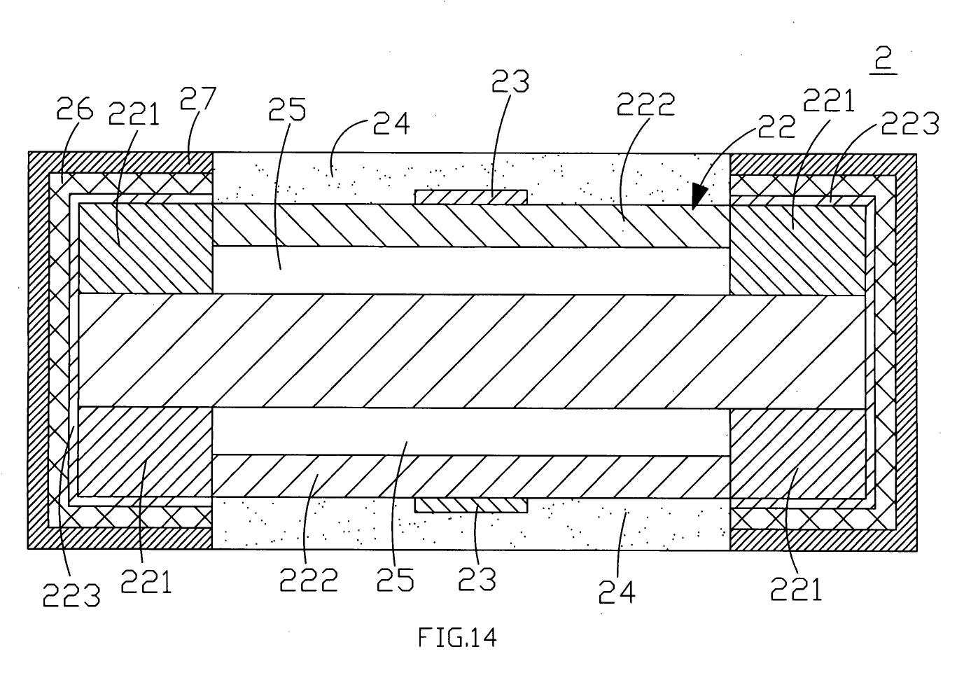

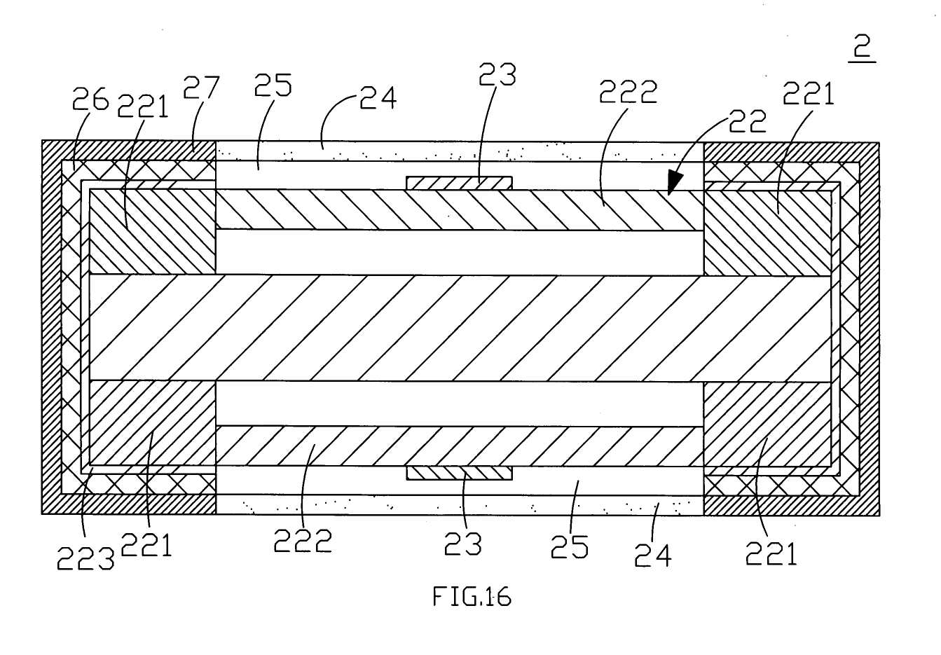

Referring to FIG. 12 for another preferred embodiment of the present invention, Step I is performed after carrying out the Steps C to H, and the Step I installs a conducting portion as shown in FIG. 14, and both sides of the insulating substrate 21 have a conducting portion 223 connected to two opposite electrode portions 221, and Steps G and H are preformed sequentially after carrying out the Step I to produce a double-sided surface mount thin film fuse structure 2 as shown in FIG. 14, wherein the Step G installs a nickel layer 26 and a tin layer 27 sequentially on surfaces of the two opposite electrode portions 221 and the conducting portion 223, and the Step H installs a protective layer 24. In the Step F, at least one space 25 is defined by the protective layer 24, the fusible link portion 222 and the tin layer 23 as shown in FIG. 16 to produce another lateral-sided surface mount thin film fuse structure 2.

It is noteworthy to point out that the present invention can improve the conventional surface mount thin film fuse structure, such that the fusible link portion and the insulating substrate are contacted directly then lead to electrically connect the fusible link portion to generated a heat source which can be conducted and dissipated from the insulating substrate, and thus the fusible link portion cannot reach a specific high temperature to blow the fusible link portion or achieve the over current protection effect. As a result, the circuits of an electric device may be damaged or burned easily. The present invention adopts a non-contact design of the fusible link portion and the insulating substrate, such that the heat source generated after the fusible link portion is connected electrically will not be conducted or dissipated from the insulating substrate to assure the effect of reaching a specific current or a specific temperature to blow the fuse, so as to achieve the effect of protecting the circuits.

While the technical contents and characteristics of the invention have been described by means of specific embodiments, numerous modifications and variations could be made thereto by those skilled in the art without departing from the scope and spirit of the invention set forth in the claims.

I claim:

1. A surface mount thin film fuse structure, comprising:
an insulating substrate, having a fusible fuse circuit structure disposed on at least one surface of the insulating substrate, and the fusible fuse circuit structure comprising two opposite electrode portions and a fusible link portion, wherein the fusible link portion is connected to the two opposite electrode portions, and at least one space is defined between the fusible link portion and the insulating substrate;
a protective layer, having the fusible link portion disposed thereon.

2. The surface mount thin film fuse structure as claimed in claim 1, wherein the insulating substrate includes a fusible fuse circuit structure disposed separately on both opposite surfaces of the insulating substrate.

3. The surface mount thin film fuse structure as claimed in claim 2, wherein the fusible link portion has a tin layer disposed at the middle of a surface of the fusible link portion, and at least one other space is defined by the protective layer, the fusible link portion and the tin layer.

4. The surface mount thin film fuse structure as claimed in claim 2, wherein the insulating substrate further comprises a conducting portion disposed separately on both lateral sides of the insulating substrate for connecting the two opposite electrode portions.

5. The surface mount thin film fuse structure as claimed in claim 4, wherein the fusible link portion has a tin layer disposed at the middle of a surface of the fusible link portion, and at least one other space is defined by the protective layer, the fusible link portion and the tin layer.

6. The surface mount thin film fuse structure as claimed in claim 4, wherein the electrode portion and the conducting portion install a nickel layer and a tin layer on surfaces of the electrode portion and the conducting portion.

7. The surface mount thin film fuse structure as claimed in claim 1, wherein the fusible link portion has a tin layer disposed at the middle of a surface of the fusible link portion.

8. The surface mount thin film fuse structure as claimed in claim 7, further comprising at least one other space defined by the protective layer, the fusible link portion and the tin layer.

9. A method of manufacturing a surface mount thin film fuse structure, comprising the steps of:
(A) providing an insulating substrate;
(B) installing a spacer layer on at least one surface of the insulating substrate and the spacer layer locating at a desired position for installing the fusible link portion;
(C) installing a copper layer on a surface of the insulating substrate having the spacer layer and covering the whole surface of the insulating substrate with the copper layer;
(D) coating a photoresist on the copper layer, and performing exposure, development and etching processes to form a fusible fuse circuit structure by the copper layer, wherein the fusible fuse circuit structure comprises two opposite electrode portions and a fusible link portion connected to the two opposite electrode portions; and
(E) removing the spacer layer to define at least one space between the fusible link portion and the insulating substrate.

10. The method of manufacturing a surface mount thin film fuse structure as claimed in claim 9, wherein the Step B installs a spacer layer separately on both opposite surfaces of the insulating substrate.

11. The method of manufacturing a surface mount thin film fuse structure as claimed in claim 9, wherein the spacer layer is made of a photoresist material, and the Step E removes the spacer layer together with the photoresist remained on the fusible fuse circuit structure.

12. The method of manufacturing a surface mount thin film fuse structure as claimed in claim 11, wherein the Step E further comprises a step F for installing a tin layer at the middle of a surface of the fusible link portion, and the Step F further comprises a step G for installing a nickel layer and a tin layer sequentially on a surface of the electrode portion, and the Step G further comprises a Step H for installing a protective layer at a position of the fusible link portion of the fusible fuse circuit structure.

13. The method of manufacturing a surface mount thin film fuse structure as claimed in claim 12, wherein the Step F further installs a second spacer layer between the fusible link portion and the tin layer, and the second spacer layer is a hot melt material having a melting point lower than the melting point of the tin layer, and the Step H removes the second spacer layer by heating after installing a protective layer.

14. The method of manufacturing a surface mount thin film fuse structure as claimed in claim 12, wherein a Step I is included between the Steps F and G, and the Step I installs a conducting portion disposed separately on both lateral sides of the insulating substrate for connecting the two opposite electrode portions.

15. The method of manufacturing a surface mount thin film fuse structure as claimed in claim 9, wherein the spacer layer is made of a hot melt material, and the spacer layer has a melting point lower than the melting point of the tin layer, and the Step E removes the spacer layer by heating, and then removes the photoresist remained on the fusible fuse circuit structure by a chemical solvent.

16. The method of manufacturing a surface mount thin film fuse structure as claimed in claim 15, wherein a Step F is included between the Steps D and E, and the Step F installs a tin layer at the middle of a surface of the fusible link portion, and a Step G is carried out after the Step E, and the Step G installs a nickel layer and a tin layer sequentially on both sides of the electrode portion, and the Step G further includes a Step H for installing a protective layer disposed at a position of the fusible link portion of the fusible fuse circuit structure.

17. The method of manufacturing a surface mount thin film fuse structure as claimed in claim 16, wherein the Step F further installs a second spacer layer between the fusible link portion and the tin layer, and the second spacer layer is a hot melt material having a melting point lower than the melting point of tin layer, and the Step H removes the second spacer layer by heating after installing the protective layer.

18. The method of manufacturing a surface mount thin film fuse structure as claimed in claim 16, wherein a Step I is included between the Steps F and G, and the Step I installs a conducting portion disposed separately on both lateral sides of the insulating substrate for connecting the two opposite electrode portions.

19. The method of manufacturing a surface mount thin film fuse structure as claimed in claim 9, wherein the spacer layer is made of a water washable and durable material, and the Step E removes the spacer layer by a high pressure water, and then removes the photoresist remained on the fusible fuse circuit structure by a chemical solvent, and the Step E further includes a Step F for installing a tin layer at the middle of a surface of the fusible link portion, and the Step F further includes a Step G for installing a nickel layer and a tin layer sequentially on surfaces of the electrode portions, and a Step H is carried out after the Step G for installing a protective layer at a position of the fusible link portion of the fusible fuse circuit structure.

20. The method of manufacturing a surface mount thin film fuse structure as claimed in claim 19, wherein the Step F installs a second spacer layer between the fusible link portion and the tin layer, and the second spacer layer is a hot melt material having a melting point lower than the melting point of the tin layer, and the Step H removes the second spacer layer by heating after installing the protective layer, and a Step I is included between the Steps F and G for installing a conducting portion disposed separately on both lateral sides of the insulating substrate for connecting the two opposite electrode portions.
